(19) United States
(12) Patent Application Publication
(10) Pub. No.: US 2026/0058395 A1
(43) Pub. Date: Feb. 26, 2026

(54) Connector

(71) Applicant: Tyco Electronics (Shanghai) Co., Ltd., Shanghai (CN)

(72) Inventors: Ke Wang, Suzhou (CN); Xiao (Nichee) Zhou, Shanghai (CN); Wei Yuan, Shanghai (CN)

(73) Assignee: Tyco Electronics (Shanghai) Co., Ltd., Shanghai (CN)

(21) Appl. No.: 19/306,332

(22) Filed: Aug. 21, 2025

(30) Foreign Application Priority Data
Aug. 23, 2024 (CN) 202411170211.X

(51) Int. Cl. H01R 13/426; H01R 4/18

(52) U.S. Cl. CPC H01R 13/426; H01R 4/185

(57) ABSTRACT

A connector includes a housing having a plurality of terminal insertion holes extending in a longitudinal direction and a pair of vertical slots opposite each other in a transverse direction, a plurality of terminals respectively inserted into the plurality of terminal insertion holes, and a pair of conductive plates respectively inserted into the pair of vertical slots. Each of the terminals has a pair of elastic parts opposite each other in the transverse direction. The plurality of terminals are arranged in rows and columns, and elastic parts of two adjacent terminals of each row electrically contact each other. One conductive plate of the pair of conductive plates is in electrical contact with elastic parts of one outermost column of terminals simultaneously, and the other conductive plate of the pair of conductive plates is in electrical contact with elastic parts of the other outermost column of terminals simultaneously.

### CROSS-REFERENCE TO RELATED APPLICATION

This application claims the benefit of the filing date under 35 U.S. C. § 119(a)-(d) of Chinese Patent Application No. 202411170211.X, filed on Aug. 23, 2024.

### FIELD OF THE INVENTION

The present invention relates to the field of electrical connections, and in particular, relates to a connector.

### BACKGROUND OF THE INVENTION

In order to achieve a quick electrical connection between cables, it is generally necessary to provide a plurality of cable connectors and an adapter connector. Each cable connector includes a housing and a terminal which is disposed in the housing and crimped onto a cable. The adapter connector includes a housing and a plurality of adapter terminals disposed in the housing. The plurality of cable connectors are inserted into the adapter connector, and the terminals of the plurality of cable connectors are electrically connected to each other via the plurality of adapter terminals. However, it is generally necessary to provide two different connectors, which increases costs and results in oversized products.

### SUMMARY OF THE INVENTION

A connector includes a housing having a plurality of terminal insertion holes extending in a longitudinal direction and a pair of vertical slots opposite each other in a transverse direction, a plurality of terminals respectively inserted into the plurality of terminal insertion holes, and a pair of conductive plates respectively inserted into the pair of vertical slots. Each of the terminals has a pair of elastic parts opposite each other in the transverse direction. The plurality of terminals are arranged in rows and columns, and elastic parts of two adjacent terminals of each row electrically contact each other. One conductive plate of the pair of conductive plates is in electrical contact with elastic parts of one outermost column of terminals simultaneously, and the other conductive plate of the pair of conductive plates is in electrical contact with elastic parts of the other outermost column of terminals simultaneously.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of the connector according to an exemplary embodiment of the present invention;

FIG. 3 shows an exploded sectional view of the connector according to an exemplary embodiment of the present invention;

FIG. 4 shows an illustrative perspective view of a plurality of terminals and a pair of conductive plates of the connector according to an exemplary embodiment of the present invention;

FIG. 5 shows an illustrative perspective view of a terminal according to an exemplary embodiment of the present invention;

FIG. 6 shows a longitudinal sectional view of the terminal according to an exemplary embodiment of the present invention;

FIG. 7 shows a horizontal sectional view of the connector according to an exemplary embodiment of the present invention; and

FIG. 8 shows a vertical sectional view of the connector according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

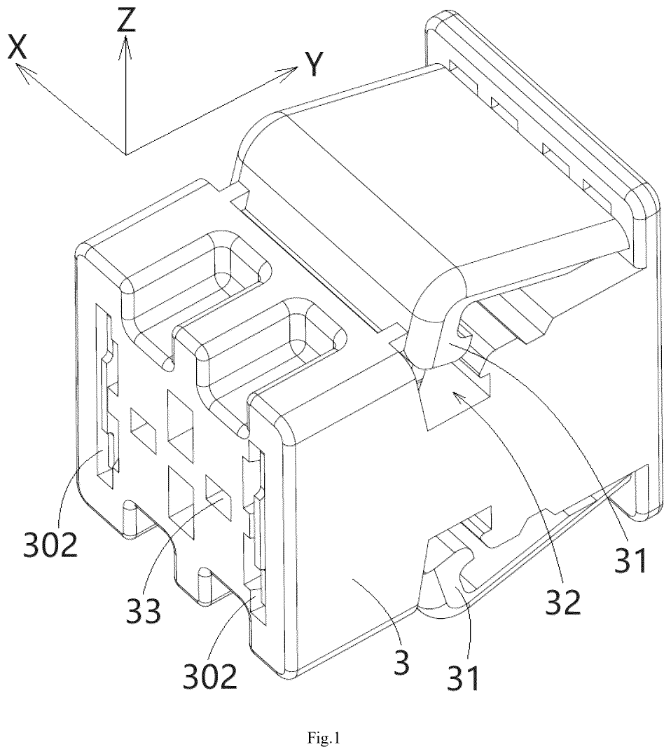

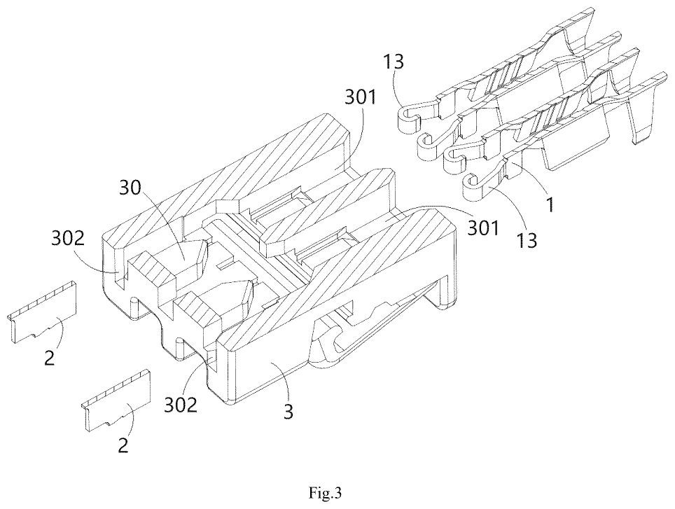

As shown in FIGS. 1 to 8, in an exemplary embodiment of the present invention, a connector is disclosed. The connector includes a housing 3, a plurality of terminals 1, and a pair of conductive plates 2. The housing 3 is formed with a plurality of terminal insertion holes 301, shown in FIG. 3, extending in a longitudinal direction Y thereof and a pair of vertical slots 302 opposite each other in a transverse direction X thereof. The plurality of terminals 1 are respectively inserted into the plurality of terminal insertion holes 301, each of the terminals 1 has a pair of elastic parts 13 opposite each other in the transverse direction. The pair of conductive plates 2 are respectively inserted into the pair of vertical slots 302. The plurality of terminals 1 are arranged in rows and columns in the transverse direction X and a height direction Z of the housing 3. In the illustrated embodiment, the row direction is the transverse direction X of the housing 3, and the column direction is the height direction Z of the housing 3.

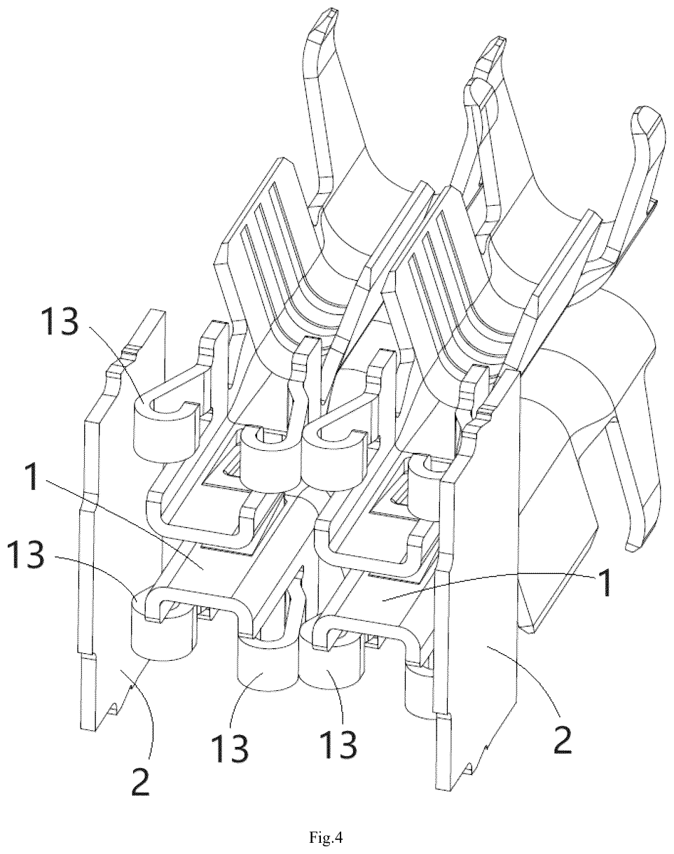

As shown in FIG. 4, in the illustrated embodiment, elastic parts 13 of two adjacent terminals 1 of each row of terminals 1 are in electrical contact with each other. One conductive plate 2 of the pair of conductive plates 2 is in electrical contact with elastic parts 13 of one outermost column of terminals 1 simultaneously, and the other conductive plate 2 of the pair of conductive plates 2 is in electrical contact with elastic parts 13 of the other outermost column of terminals 1 simultaneously.

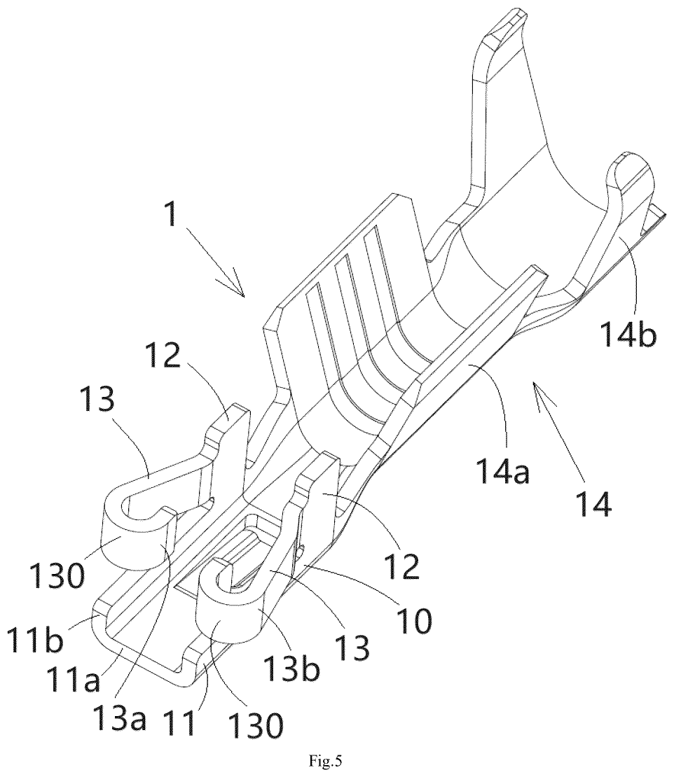

As shown in FIG. 5, in the illustrated embodiment, the terminal 1 further includes a fixing portion 10. The fixing portion 10 includes a pair of side plates 12 oppositely spaced in the transverse direction X. The pair of elastic parts 13 are respectively connected to the pair of side plates 12 at one end, and each of the elastic parts 13 has a contact portion 130 that is located at the other end thereof and bent into a hook shape. Contact portions 130 of two adjacent terminals 1 of each row of terminals 1 are in electrical contact with each other. One of the conductive plates 2 is in electrical contact with contact portions 130 of one outermost column of terminals 1 simultaneously, and the other conductive plate 2 is in electrical contact with contact portions 130 of the other outermost column of terminals 1 simultaneously, as shown in FIG. 4.

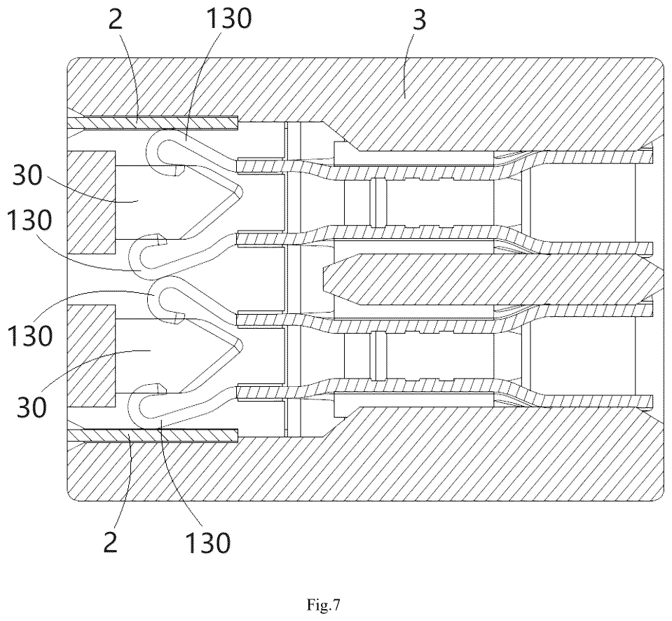

As shown in FIG. 5, in the illustrated embodiment, the contact portion 130 has an inner side 13a and an outer side 13b opposite each other in the transverse direction X. An outer side 13b of a contact portion 130 of one terminal 1 is configured to be in electrical contact with an outer side 13b of a contact portion 130 of another terminal 1 transversely adjacent thereto to establish an electrical connection of the two transversely adjacent terminals 1, as shown in FIG. 7.

As shown in FIG. 3, in the illustrated embodiment, a tongue 30 is formed in each of the terminal insertion holes 301 of the housing 3. The tongue 30 is inserted between the pair of elastic parts 13 of the terminal 1 and abuts against the inner sides 13a of the contact portions 130 of the pair of elastic parts 13 to enable the contact portions 130 of the two transversely adjacent terminals 1 to be in reliable electrical contact with each other.

As shown in FIG. 7, in the illustrated embodiment, a spacing between the contact portions 130 of the pair of elastic parts 13 is smaller than a width of the tongue 30 in the transverse direction X, such that the contact portions 130 of the pair of elastic parts 13 are elastically deformed and generate a predetermined elastic contact force under the action of the tongue 30 inserted therebetween to ensure the contact portion 130 of one terminal 1 to be in reliable electrical contact with the contact portion 130 of another terminal 1 transversely adjacent thereto.

As shown in FIG. 5, in the illustrated embodiment, the elastic part 13 is cantilevered, and has the end thereof bent toward the inside between the pair of elastic parts 13 to form a hook-shaped contact portion 130.

As shown in FIG. 5, in the illustrated embodiment, the fixing portion 10 further includes a base 11. The base 11 includes a bottom wall 11a extending in the longitudinal direction Y and a pair of side walls 11b respectively located on two sides of the bottom wall 11a in the transverse direction X. The pair of side plates 12 are respectively connected to upper sides of the pair of side walls 11b of the base 11 and extend upward in the height direction Z. The pair of elastic parts 13 are respectively connected to front sides of the pair of side plates 12 and are suspended above the base 11.

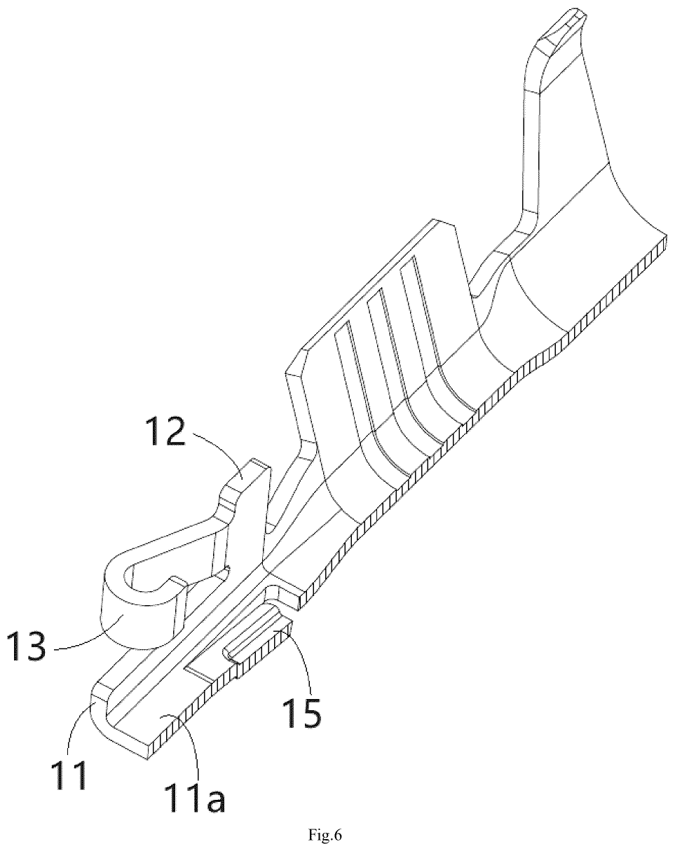

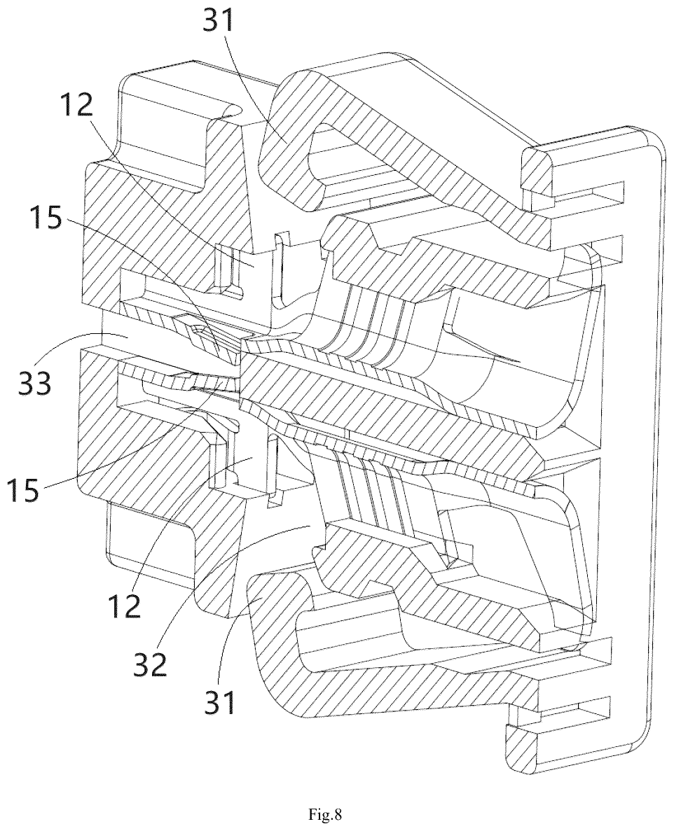

As shown in FIG. 6, in the illustrated embodiment, a primary locking spring tab 15 is formed on the bottom wall 11a of the fixing portion 10, and is configured to engage with a primary locking slot 33 in the terminal insertion hole 301 of the housing 3 to lock the terminal 1 into the terminal insertion hole 301, as shown in FIG. 8.

As shown in FIGS. 1 and 8, in the illustrated embodiment, a secondary locking snap-fit member 31 and a secondary locking slot 32 are respectively formed on a top portion and a bottom portion of the housing 3. The secondary locking snap-fit member 31 is movable between a locked position in which the secondary locking snap-fit member 31 is engaged with the secondary locking slot 32 and a release position in which the secondary locking snap-fit member 31 is disengaged from the secondary locking slot 32. When the secondary locking snap-fit member 31 is moved to the locked position, the secondary locking snap-fit member 31 abuts against a rear side of the side plate 12 of the terminal 1 to lock the terminal 1 into the terminal insertion hole 301 of the housing 3.

As shown in FIG. 5, in the illustrated embodiment, the terminal 1 further includes a crimping portion 14 configured to be crimped onto a cable to establish an electrical connection with the cable. The crimping portion 14 is connected to a rear end of the base 11 and extends rearward in the longitudinal direction Y. In the illustrated embodiment, the crimping portion 14 of the terminal 1 includes a first crimping portion 14a and a second crimping portion 14b. The first crimping portion 14a is configured to be crimped onto a conductor of the cable. The second crimping portion 14b is configured to be crimped onto an outer sheath layer of the cable. The first crimping portion 14a is connected between the rear end of the base 11 and the second crimping portion 14b.

In an embodiment, the connector further includes a plurality of cables respectively electrically connected to the plurality of terminals 1 and led out from a rear end of the housing 3.

In the illustrated embodiment, the terminal 1 is an integral stamped part, and the housing 3 is an integral overmolded part.

In the illustrated embodiment, the connector comprises four terminals 1 arranged in two rows and two columns in the transverse direction X and the height direction Z of the housing 3. However, the present invention is not limited to the illustrated embodiment. For example, the connector may also include six terminals 1, which are arranged in two rows and three columns.

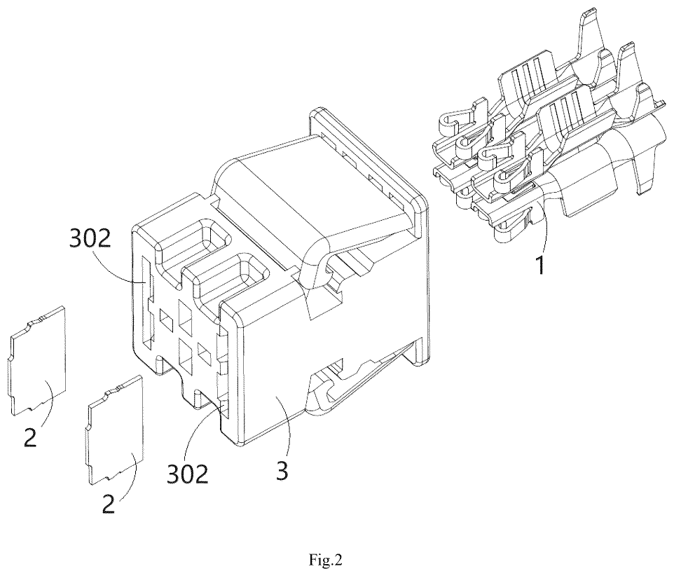

As shown in FIG. 2, in the illustrated embodiment, two terminals 1 adjacent to each other in the height direction Z are arranged in the housing 3 in a back-to-back manner, such that bottom walls 11a of the two terminals 1 adjacent to each other in the height direction Z face each other.

In the aforementioned exemplary embodiments according to the present invention, two transversely adjacent terminals in the connector are in direct electrical contact with each other, and the two outermost columns of terminals are respectively in electrical contact with the conductive plates, so that the plurality of terminals of the connector are electrically connected to each other. Therefore, in the present invention, there is no need to provide an additional adapter connector, thereby simplifying the structure of the connector product, reducing the manufacturing cost, and reducing the size of the connector product.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing having a plurality of terminal insertion holes extending in a longitudinal direction and a pair of vertical slots opposite each other in a transverse direction;
a plurality of terminals respectively inserted into the plurality of terminal insertion holes, each of the terminals having a pair of elastic parts opposite each other in the transverse direction, the plurality of terminals are arranged in rows and columns in the transverse direction and a height direction of the housing, and elastic parts of two adjacent terminals of each row of terminals are in electrical contact with each other, each of the terminals has a crimping portion crimpable onto a cable to establish an electrical connection with the cable; and
a pair of conductive plates respectively inserted into the pair of vertical slots, one conductive plate of the pair of conductive plates is in electrical contact with elastic parts of one outermost column of terminals simultaneously, and the other conductive plate of the pair of conductive plates is in electrical contact with elastic parts of the other outermost column of terminals simultaneously.

2. The connector according to claim 1, wherein each of the terminals has a fixing portion with a pair of side plates oppositely spaced in the transverse direction, the pair of elastic parts are respectively connected to the pair of side plates at one end, and each of the elastic parts has a contact portion that is located at the other end thereof and bent into a hook shape.

3. The connector according to claim 2, wherein contact portions of two adjacent terminals of each row of terminals are in electrical contact with each other, one of the conductive plates is in electrical contact with contact portions of one outermost column of terminals simultaneously, and the other conductive plate is in electrical contact with contact portions of the other outermost column of terminals simultaneously.

4. The connector according to claim 3, wherein the contact portion has an inner side and an outer side opposite each other in the transverse direction, an outer side of a contact portion of one terminal is in electrical contact with an outer side of a contact portion of another terminal transversely adjacent thereto to establish an electrical connection of the two transversely adjacent terminals.

5. The connector according to claim 4, wherein a tongue is formed in each of the terminal insertion holes of the housing, the tongue is inserted between the pair of elastic parts of the terminal and abuts against the inner sides of the contact portions of the pair of elastic parts.

6. The connector according to claim 5, wherein a spacing between the contact portions of the pair of elastic parts is smaller than a width of the tongue in the transverse direction, the contact portions of the pair of elastic parts are elastically deformed and generate a predetermined elastic contact force with the tongue inserted therebetween to ensure the contact portion of one terminal to be in reliable electrical contact with the contact portion of another terminal transversely adjacent thereto.

7. The connector according to claim 2, wherein each of the elastic parts is cantilevered and has the end thereof bent toward an inside between the pair of elastic parts.

8. The connector according to claim 2, wherein the fixing portion has a base, the base has a bottom wall extending in the longitudinal direction and a pair of side walls respectively located on two sides of the bottom wall in the transverse direction.

9. The connector according to claim 8, wherein the pair of side plates are respectively connected to a pair of upper sides of the pair of side walls of the base and extend upward in the height direction, the pair of elastic parts are respectively connected to front sides of the pair of side plates and are suspended above the base.

10. The connector according to claim 9, wherein a primary locking spring tab is formed on the bottom wall of the fixing portion, the primary locking spring tab engages with a primary locking slot in one of the terminal insertion holes of the housing to lock the terminal into the one of the terminal insertion holes.

11. The connector according to claim 9, wherein a secondary locking snap-fit member and a secondary locking slot are respectively formed on a top portion and a bottom portion of the housing, the secondary locking snap-fit member is movable between a locked position in which the secondary locking snap-fit member is engaged with the secondary locking slot and a release position in which the secondary locking snap-fit member is disengaged from the secondary locking slot.

12. The connector according to claim 11, wherein, when the secondary locking snap-fit member is moved to the locked position, the secondary locking snap-fit member abuts against a rear side of the side plate of the terminal to lock the terminal into the terminal insertion hole of the housing.

13. The connector according to claim 9, wherein the crimping portion is connected to a rear end of the base and extends rearward in the longitudinal direction.

14. The connector according to claim 13, wherein the crimping portion includes a first crimping portion crimpable onto a conductor of the cable and a second crimping portion crimpable onto an outer sheath layer of the cable, the first crimping portion is connected between the rear end of the base and the second crimping portion.

15. The connector according to claim 1, wherein the cable is one of a plurality of cables respectively electrically connected to the plurality of terminals and led out from a rear end of the housing.

16. The connector according to claim 1, wherein the terminal is an integral stamped part, and the housing is an integral overmolded part.

17. The connector according to claim 1, wherein the plurality of terminals include four terminals arranged in two rows and two columns in the transverse direction and the height direction of the housing.

18. The connector according to claim 17, wherein two terminals adjacent to each other in the height direction are arranged in the housing in a back-to-back manner, such that bottom walls of the two terminals adjacent to each other in the height direction face each other.
